(19) United States
(12) Patent Application Publication
(10) Pub. No.: US 2020/0164641 A1
(43) Pub. Date: May 28, 2020

(54) INKJET RECORDING APPARATUS AND PROGRAM THEREOF

(71) Applicant: Konica Minolta Inc., Tokyo (JP)

(72) Inventor: KENGO CHIHARA, Tokyo (JP)

(21) Appl. No.: 16/693,952

(22) Filed: Nov. 25, 2019

(30) Foreign Application Priority Data
Nov. 28, 2018 (JP) 2018-221914

(51) Int. Cl. B41J 2/045

(52) U.S. Cl. CPC B41J 2/04563; B41J 2/04581

(57) ABSTRACT

An inkjet recording apparatus ejects an ink droplet from a recording head to record an image on a recording medium, and includes: a heat source that heats the recording head; a temperature sensor that detects a temperature of the recording head; a carriage to which the recording head is attached; and a hardware processor that makes determination on whether there is a mechanical defect in attaching the recording head to the carriage on the basis of transition of the temperature detected by the temperature sensor at a time when the heat source heats the recording head.

The entire disclosure of Japanese patent Application No. 2018-221914, filed on Nov. 28, 2018, is incorporated herein by reference in its entirety.

### BACKGROUND

### Technological Field

The present invention relates to an inkjet recording apparatus that ejects ink droplets from a recording head to record an image on a recording medium.

### Description of the Related Art

In an inkjet recording apparatus, a plurality of recording heads is attached to a strong member called a carriage for the purpose of improving impact accuracy. In addition, since a recording head is normally used after being heated to a target temperature with a heater to stabilize ink ejection, the carriage also has the purpose of releasing the heat. Furthermore, by the recording head being attached to the carriage, a contact provided on the carriage side and a contact on the recording head side come into contact with each other so that electrical connection is made simultaneously.

If there is a defect in attaching the recording head to the carriage, problems may be raised such as follows:
The heat of the recording head cannot be released properly to the carriage and the temperature of the recording head exceeds a proper temperature range;
The recording head is tilted relative to a proper attachment position so that an ink ejection direction is made to be incorrect, which results in poor image quality; and
A defect in electrical connection occurs.

Meanwhile, when both ends or the like of the recording head are brought in close contact with the carriage to be attached thereto, it is difficult to visually detect a slight defect in attachment. In view of the above, conventionally, actual printing is carried out to determine whether there is a defect in attachment from a result of the printing. However, this method consumes resources, such as ink and recording media.

JP 2000-190503 A discloses an inkjet recording apparatus that reads, for example, resistance value information of a heater in a head to determine whether a detachable head is attached while electrically connected in a proper manner, and controls the heater in the head to be turned on after the proper electrical connection is confined.

Furthermore, JP 2014-177081 A discloses an inkjet printer that determines whether there is a defect in electrical connection of a head on the basis of the presence or absence of a voltage drop across a capacitor when a heater inside the head is energized from the capacitor.

While a defect in electrical connection at the time when a recording head is attached is detected in JP 2000-190503 A and JP 2014-177081 A, a mechanical defect in attachment, for example, a slight defect in attachment such as a case where one end of the recording head is attached to be slightly lifted while both ends of the recording head should be attached in close contact with a carriage, cannot be automatically detected. Such a mechanical defect in attachment may occur at times even if electrical connection is normal.

### SUMMARY

The present invention has been conceived to solve the problem mentioned above, and an object of the present invention is to provide an inkjet recording apparatus and a program thereof capable of detecting a mechanical defect in attaching a recording head to a carriage without printing.

To achieve the abovementioned object, according to an aspect of the present invention, there is provided an inkjet recording apparatus that ejects an ink droplet from a recording head to record an image on a recording medium, and the inkjet recording apparatus reflecting one aspect of the present invention comprises: a heat source that heats the recording head; a temperature sensor that detects a temperature of the recording head; a carriage to which the recording head is attached; and a hardware processor that makes determination on whether there is a mechanical defect in attaching the recording head to the carriage on the basis of transition of the temperature detected by the temperature sensor at a time when the heat source heats the recording head.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating a schematic configuration of an inkjet recording apparatus according to an embodiment of the present invention.

FIG. 2 is a view illustrating an ink ejection surface (bottom surface) of a recording head unit;

FIG. 3 is a view illustrating a front surface of the recording head unit;

FIG. 4 is a front view of a recording head;

FIG. 5 is a back view of the recording head;

FIG. 6 is a diagram illustrating an internal structure of an ejection head;

FIG. 7 is a diagram illustrating a state in which the recording head is correctly attached to a carriage,

FIG. 8 is a diagram illustrating an exemplary state in which there is a defect in attaching the recording head to the carriage:

FIG. 9 is a graph illustrating temperature transition when the recording head is heated to a target temperature by a heater as a printing preparation operation, which is illustrated to compare a normal state and a defective attachment state; and

FIG. 10 is a flowchart illustrating a process performed by a defective attachment detection unit.

### DETAILED DESCRIPTION OF EMBODIMENTS

Hereinafter, one or more embodiments of the present invention will be described with reference to the drawings. However, the scope of the invention is not limited to the disclosed embodiments.

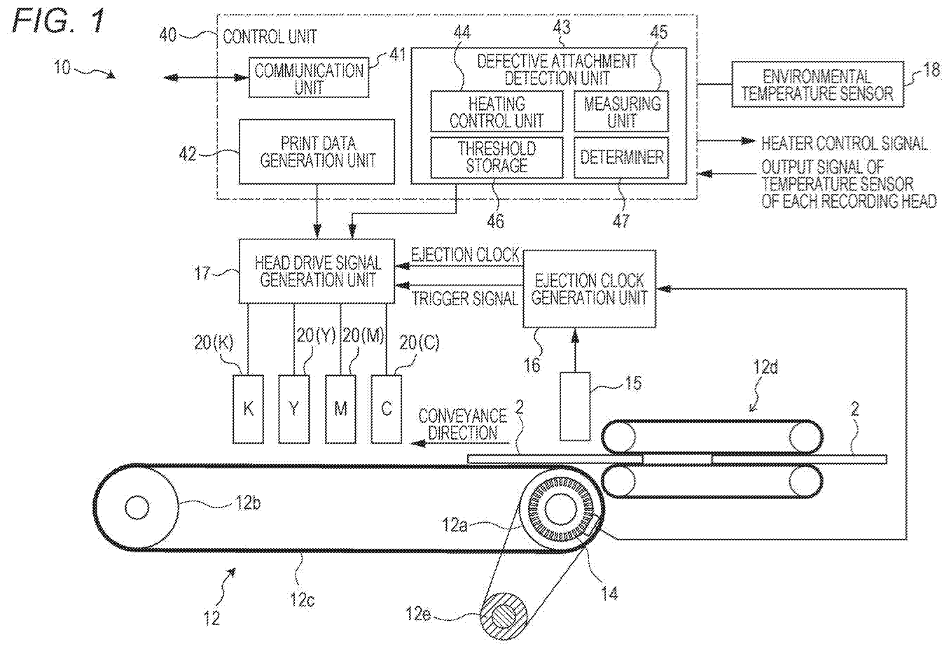

FIG. 1 illustrates a schematic configuration of an inkjet recording apparatus 10 according to an embodiment of the present invention. The inkjet recording apparatus 10 is an apparatus that ejects ink droplets from a recording head to record an image on a sheet-like recording medium 2, such as paper, cloth, and film.

The inkjet recording apparatus 10 includes a conveyer 12 that conveys the recording medium 2 by causing a conveying belt 12c stretched around a drive shaft 12a and a driven shaft 12b to circle, and recording head units 20 of respective colors of cyan (C), magenta (M), yellow (Y), and black (K) that eject ink toward the recording medium 2 conveyed by the conveying belt 12c. The recording head units 20 are arranged along the conveying belt 12c in the order of C, M, Y, and K from the upstream side to the downstream side in the conveyance direction in which the conveying belt 12c conveys the recording medium 2. The conveyer 12 further includes a sheet feeding mechanism 12d that feeds and conveys the recording medium 2 from a sheet feeding tray (not illustrated) to deliver it to the conveying belt 12c.

The drive shaft 12a around which the conveying belt 12c is stretched rotates as rotation of a motor 12e is transmitted through a transmission belt. A rotary encoder 14 is attached to the drive shaft 12a. The rotary encoder 14 outputs a reference pulse (Z-phase signals) each time the drive shaft 12a rotates once, and outputs a large number of pulses (A-phase signals) each predetermined angle of rotation while the drive shaft 12a rotates once.

In the vicinity of the upstream end of the conveying belt 12c, there is provided a medium passage sensor 15 that detects the recording medium 2 delivered from the sheet feeding mechanism 12d and passing through the portion.

The inkjet recording apparatus 10 further includes an ejection clock generation unit 16, a head drive signal generation unit 17, an environmental temperature sensor 18, a control unit 40, and the like. The head drive signal generation unit 17 and the environmental temperature sensor 18 are connected to the control unit 40.

The ejection clock generation unit 16 inputs the A-phase and Z-phase pulses output from the rotary encoder 14 and output signals of the medium passage sensor 15, and generates, on the basis of them, trigger signals indicating timing for starting printing and ejection clock signals to be a reference for print timing in each line to output the signals to the head drive signal generation unit 17.

The head drive signal generation unit 17 outputs, to the recording head unit 20, drive signals whose timing is controlled on the basis of the trigger signals and the ejection clock signals.

The environmental temperature sensor 18 detects the temperature of the installation environment of the inkjet recording apparatus 10.

The control unit 40 is control circuitry mainly including a central processing unit (CPU), a read-only memory (ROM), a random access memory (RAM), and the like, and operations related to various functions of the inkjet recording apparatus 10 are controlled by the CPU executing various kinds of processing in accordance with programs stored in the ROM.

The control unit 40 functions as a communication unit 41, a print data generation unit 42, and a defective attachment detection unit 43. The communication unit 41 communicates with an external device via a network or the like to receive a print job. The print data generation unit 42 generates print data corresponding to an image to be printed by performing processing of a raster image processor (RIP) or the like on the basis of the received print job, and outputs the print data to the head drive signal generation unit 17. The head drive signal generation unit 17 generates drive signals according to the print data input from the print data generation unit 42, and outputs the signals to the recording head unit 20.

The defective attachment detection unit 43 detects a mechanical defect in attachment of the recording head unit 20. The defective attachment detection unit 43 functions as a heating control unit 44, a measuring unit 45, a threshold storage 46, and a determiner 47. Details of those components will be described after a structure of the recording head unit 20 is described.

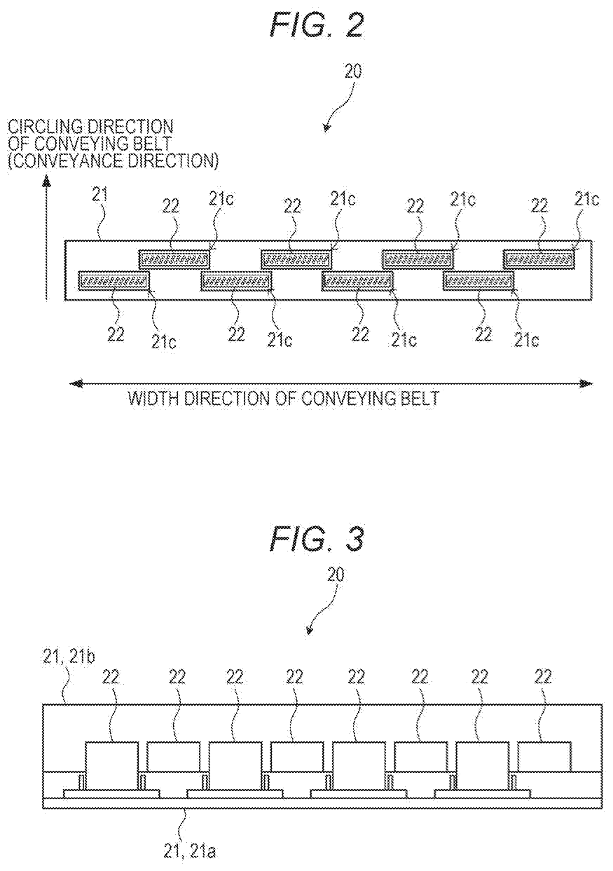

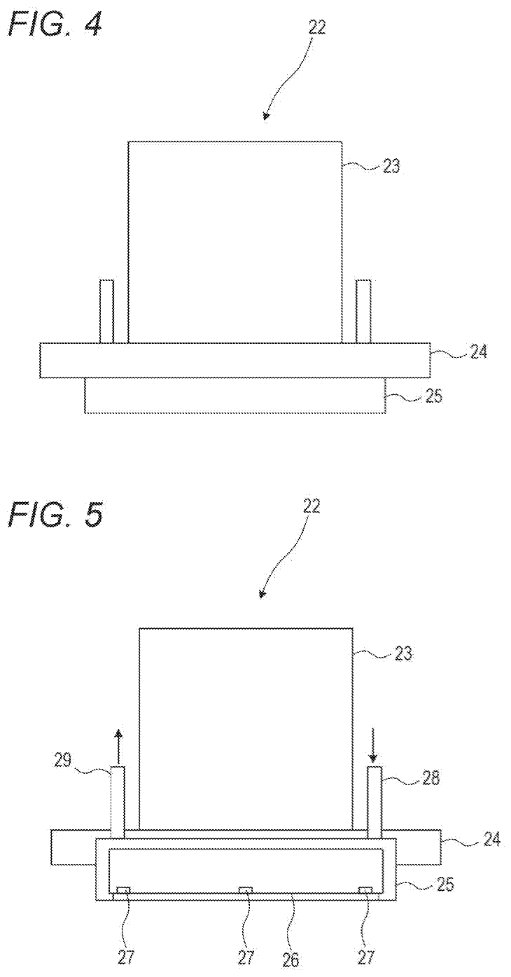

FIG. 2 illustrates an ink ejection surface (bottom surface) of the recording head unit 20, and FIG. 3 illustrates a front surface of the recording head unit 20. The recording head unit 20 is configured in such a manner that a plurality of recording heads 22 is attached to a carriage 21. Here, eight recording heads 22 are arranged in a staggered pattern along the width direction of the conveying belt 12c. The carriage 21 includes a bottom plate 21a and a side plate 21b, and is made of, for example, a metal plate having high rigidity and high thermal conductivity with an L-shaped cross section, and the bottom plate 21a has a rectangular head-attaching opening 21c into which an ejection head 25 (see FIG. 4) at the tip of each of the recording heads 22 to be attached to the carriage 21 is fitted.

FIG. 4 illustrates a front view of the recording head 22, and FIG. 5 illustrates a back view of the recording head 22. The recording head 22 includes a rectangular parallelepiped housing 23, an attachment part 24 projecting outward from the outer periphery of the housing 23 under the housing 23, and the ejection head 25 slightly smaller than the attachment part 24 and projecting further below the attachment part 24.

As illustrated in FIG. 5, a plane heater (heat source) 26 for heating the ejection head 25 is provided on the outer surface on the back side of the ejection head 25. In addition, temperature sensors 27 including thermistors or the like are provided at various positions of the ejection head 25. In this case, the temperature sensors 27 are attached in the vicinity of the right and left ends of the ejection head 25, and at the center thereof.

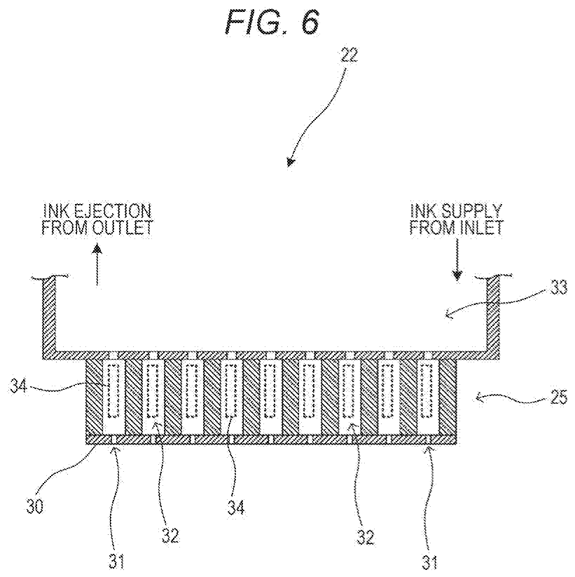

FIG. 6 illustrates an internal structure of the ejection head 25. A large number of nozzles 31 for ejecting ink are provided on the bottom surface (nozzle plate 30) of the ejection lead 25. The inside of the ejection head 25 is divided into a large number of small individual ink chambers 32 with a lead chip serving as a partition, and each of the individual ink chambers 32 communicates with one corresponding nozzle 31. Each of the individual ink chambers 32 communicates with an ink chamber 33 common to them. Ink is supplied from an inlet 28 illustrated in FIG. 5 to the ink chamber 33, and excess ink in the ink chamber 33 is discharged from an outlet 29.

Each of the individual ink chambers 32 is provided with a piezoelectric element 34 serving as a driver, and when the piezoelectric element 34 is deformed in response to the drive signals supplied from the lead drive signal generation unit 17, the ink inside the individual ink chamber 32 is pressed by the piezoelectric element 34 to be ejected from the nozzle 31. The piezoelectric element 34 generates heat when it is driven.

The control unit 40 outputs control signals for the heater 26. Further, output signals of the temperature sensor 27 included in each of the recording heads 22 are input.

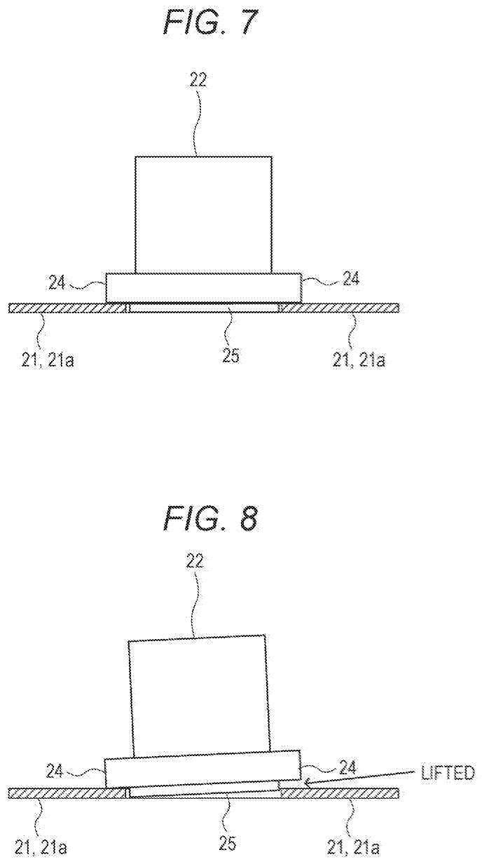

FIG. 7 is a diagram illustrating a state in which the recording head 22 is correctly attached to the carriage 21. The recording lead 22 is positioned by the ejection head 25 being fitted in the head-attaching opening 21c provided in the bottom plate 21a of the carriage 21, and is attached to the carriage 21 with the right and left ends of the attachment part 24 being in close contact with the bottom plate 21a of the carriage 21.

FIG. 8 illustrates an exemplary state in which there is a mechanical defect in attaching the recording head 22 to the carriage 21. In FIG. 8, the right end of the attachment part 24 of the recording head 22 is not in close contact with the bottom plate 21a of the carriage 21, and is slightly lifted from the bottom plate 21a.

The defective attachment detection unit 43 of the control unit 40 performs control for detecting such defective attachment of the recording head 22. Specifically, the quality of the attachment is determined on the basis of transition in the temperature of the recording head 22 at the time of heating the recording head 22 with the heat source, such as the heater 26.

As illustrated in FIG. 7, in a case where the attachment part 24 of the recording head 22 is properly attached in close contact with the bottom plate 21a of the carriage 21, heat is transmitted to the carriage 21 and is dispersed even if heating is performed by the heater 26, whereby the transition (climb gradient) in temperature detected by the temperature sensor 27 in the recording head 22 is gentle.

On the other hand, as illustrated in FIG. 8, in a case where there is defect attachment such that the attachment part 24 of the recording lead 22 is slightly lifted from the bottom plate 21a of the carriage 21, heat on the side of the recording head 22 is hardly dispersed to the carriage 21 at the time when the heater 26 heats the recording head 22, whereby the climb gradient in temperature detected by the temperature sensor 27 in the recording head 22 increases compared to the case of correct attachment.

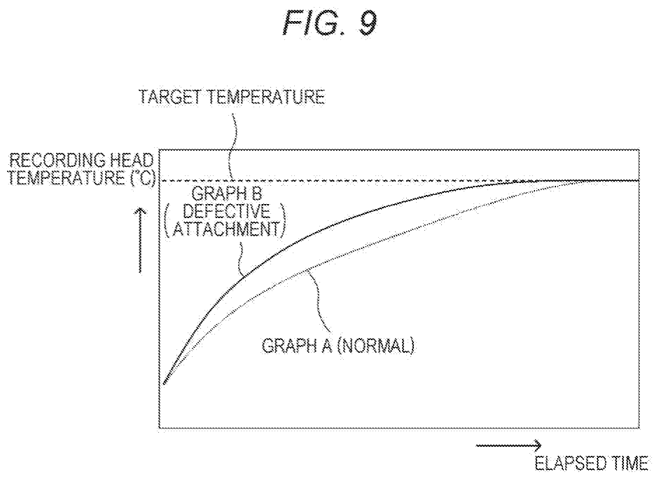

FIG. 9 illustrates temperature transition when control is performed such that the recording head 22 is heated to a target temperature by the heater 26 as a printing preparation operation. A graph A illustrated in a broken line indicates temperature transition in the case where the recording head 22 is properly attached to the carriage 21, and a graph B illustrated in a solid line indicates temperature transition in the case where there is defective attachment. In the case of the defective attachment, the heat of the recording head 22 is hardly dispersed to the carriage 21, whereby the climb gradient of the temperature increases compared to the case of the proper attachment.

The defective attachment detection unit 43 detects defective attachment of the recording head 22 to the carriage 21 on the basis of such a difference in temperature transition.

The heating control unit 44 in the defective attachment detection unit 43 illustrated in FIG. 1 performs control to energize the heat source, such as the heater 26 of each of the recording heads 22, to heat the recording heads 22. The measuring unit 45 records the temperature transition detected by the temperature sensor 27 of each of the recording heads 22 at the time when the heating control unit 44 heats each of the recording heads 22 with the heat source, such as the heater 26. Specifically, the temperature detected by the temperature sensor 27 of each of the recording heads 22 is associated with the elapsed time at the detection time point from the heating start at a predetermined sampling interval from the time point of the heating start, and is recorded.

The determiner 47 determines whether there is defective attachment on the basis of temperature transition measured by the measuring unit 45. For example, a climb gradient of the temperature after a predetermined time has elapsed from the heating start is obtained, and it is determined whether there is defective attachment on the basis of whether the obtained climb gradient is equal to or higher than a predetermined threshold value. The climb gradient may be sampled at a plurality of time points from the heating start, and all of them may be considered to determine whether there is defective attachment. Furthermore, the climb gradient of the temperature at the time point when the temperature has increased to N % (any ratio, such as 50% and 75%) of the difference between the temperature at the time point of the heating start and the target temperature may be compared with a threshold value to determine whether there is defective attachment. A time point when the temperature gradient is compared with the threshold value or the like may be determined as appropriate within a range in which accuracy in determination is secured.

A threshold value to serve as a determination criterion is registered in advance in the threshold storage 46. More specifically, a plurality of threshold tables in which threshold values are registered for each attachment position of the recording head 22 is stored for each environmental temperature. That is, a threshold value is registered for each position in the carriage 21 of the recording head 22 in one threshold table, and a plurality of the threshold tables is registered for each environmental temperature.

In a case where a plurality of the recording heads 22 is mounted on the carriage 21, the temperature of the recording head 22 sandwiched between other recording heads 22 is more likely to increase during heating than the recording head 22 positioned at the end of the carriage 21. In view of the above, a threshold value to serve as a criterion for determining defective attachment is varied depending on the attached position of the recording head 22 in the carriage 21.

Furthermore, the lower the environmental temperature, the more difficult the temperature of the recording head 22 increases, whereby a threshold value to serve as a criterion for determining defective attachment is varied depending on the temperature detected by the environmental temperature sensor 18.

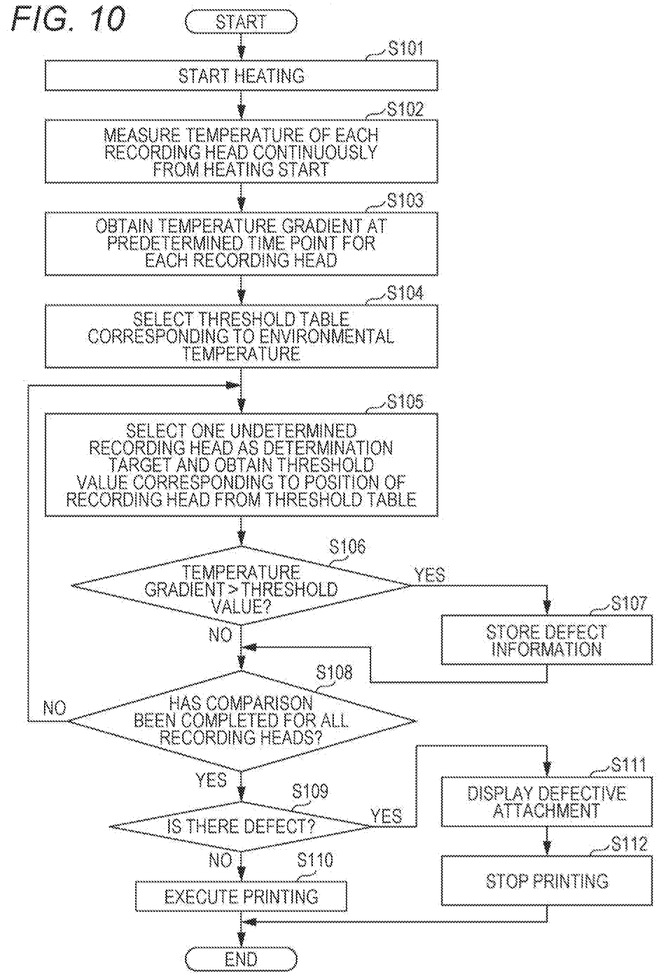

FIG. 10 is a flowchart illustrating a control process performed by the defective attachment detection unit 43. The process is executed by the CPU of the control unit 40 in accordance with a program.

Here, determination of defective attachment is made in the printing preparation operation. That is, since printing operation of ejecting ink needs to be started after the recording head 22 is heated to the target temperature, defective attachment of the recording head 22 is detected on the basis of the temperature transition at the time when the recording head 22 is heated to the target temperature as the printing preparation operation.

The heating control unit 44 turns on the heater 26 of each of the recording heads 22, and heats it to the target temperature (step S101). The measuring unit 45 measures the temperature at the time point of the heating start and the temperature detected by the temperature sensor 27 of each of the recording heads 22 at a predetermined sampling interval from the time point of the heating start, and records them in association with the elapsed time from the heating start (step S102).

The determiner 47 obtains a gradient of the measured temperature at a predetermined time point for each of the recording heads 22 (step S103). For example, a temperature gradient at a predetermined point, such as after a certain time has elapsed from the heating start, and a time point at which the temperature has increased to N % (e.g., half) of the difference between the temperature at the heating start and the target temperature.

Next, the determiner 47 selects a threshold table corresponding to the environmental temperature (step S104). Then, one undetermined recording head 22 is selected as an object to be determined, and a threshold value corresponding to the position of the recording head 22 in the carriage 21 is obtained from the threshold table selected in step S104 (step S105). Note that a basic threshold value may be corrected according to the environmental temperature, or may be corrected according to the position of the recording head 22, thereby deriving a threshold value corresponding to the position of the recording head 22 and the current environmental temperature.

Next, the temperature gradient obtained in step S103 for the recording head 22 to be determined is compared with the threshold value obtained in step S105 (S106). If the temperature gradient is equal to or higher than the threshold value (Yes in step S106), it is determined that there is a mechanical defect in attachment, the recording head 22 is recorded in a determination history as a recording head with a defect in attachment (step S107), and the process proceeds to step S108. If the temperature gradient is not equal to or higher than the threshold value (No in step S106), it is determined to be normal attachment, and the process proceeds to step S108.

In step S108, it is checked whether determination on defective attachment has been complete for all of the recording heads 22, and if it is not complete (No in step S108), the process returns to step S105 and continues.

If determination on defective attachment has been complete for all of the recording heads 22 (Yes in step S108), it is checked whether there is a recording head 22 having been determined to be defectively attached with reference to the determination history (step S109). If the recording head 22 having been determined to be defectively attached is recorded in the determination history (Yes in step S109), it is displayed that there is a defect in attachment of the recording head 22 (step S111), printing is stopped thereafter (step S112), and the process is terminated. In step S111, identification information (which position of the recording head 22 in which of the recording head units 20 of C, M, Y, and K, etc.) of the recording head 22 in which defective attachment is detected is preferably displayed.

If the recording head 22 having been determined to be defectively attached is not recorded in the determination history (No in step S109), printing is executed (step S110), and the process is terminated.

As described above, the inkjet recording apparatus 10 according to the embodiment of the present invention is capable of detecting defective attachment of the recording head 22 without performing actual printing. In addition, defective attachment of the recording head 22 is determined on the basis of the temperature transition at the time of heating the recording head 22 as a printing preparation operation, whereby actual printing is stopped to suppress wasted printing in the case where a defect is defected.

<Variation 1>

Instead of heating the recording head 22 using the heater 26 in the recording head 22 as a heat source, the piezoelectric element 34 included in the recording head 22 may serve as a heat source and may be driven to such an extent that ink is not ejected, thereby heating the recording head 22. Note that the heating based on the driving of the piezoelectric element 34 may be used in combination with the heating based on the heater 26. In that case, the defective attachment detection unit 43 instructs the head drive signal generation unit 17 to drive the piezoelectric element 34 to such an extent that ink is not ejected, and the head drive signal generation unit 17 outputs drive signals to the piezoelectric element 34 of each of the recording heads 22 in accordance with the instruction.

<Variation 2>

Instead of detecting the temperature of the recording head 22 using the temperature sensor 27 in the recording head 22, a temperature sensor may be provided in the carriage 21 in the vicinity of the recording head 22 to measure a temperature at that location. In the case of measuring the temperature of the carriage 21, a temperature gradient in the case where there is defective attachment is smaller than a temperature gradient in the case where the recording head 22 is properly attached. Accordingly, it is determined that there is defective attachment in the case where the measured temperature gradient is smaller than the threshold value. Note that, according to this method, in a case where a plurality of the recording heads 22 is attached in close proximity to the carriage 21, a temperature measured for one recording head 22 is likely to be affected by the adjacent recording head 22. Therefore, a temperature sensor corresponding to each of the recording heads 22 is preferably provided at a position where the recording head 22 is in close contact with the carriage 21 in the case of proper attachment or in the vicinity thereof.

<Variation 3>

The recording head 22 having a defect in attachment is detected by transitions of the temperatures measured for a plurality of the recording heads 22 being compared with each other. For example, since eight recording heads 22 are attached to the recording head unit 20, if one of them has a defect in attachment, a difference of a certain level or more is generated between a climb gradient of the temperature measured for the recording head 22 with the defect in attachment and a climb gradient of the temperature measured for other recording heads 22 properly attached.

In view of the above, temperature gradients measured for the plurality of recording heads 22 are compared with each other, and the recording head 22 having a difference of a certain level or more relative to others is determined to be defectively attached. Note that, instead of determining whether there is a defect on the basis of a majority rule, for example, if a temperature gradient becomes larger in the case where there is defective attachment than in a normal case, it is sufficient if the recording head 22 having the smallest temperature gradient serves as a criterion and a recording head having a temperature gradient a certain level or more larger than the criterion is determined to be defectively attached.

The comparison is preferably carried out after correcting the temperature gradient obtained from the measurement result according to the position of the recording head 22 such that the influence of the position of the recording head 22 is cancelled. Note that, since the influence of the environmental temperature is considered to equally appear in any recording head 22 in the determination based on the comparison, it becomes possible to make a determination with the influence of the environmental temperature being cancelled without the need to switch the threshold value depending on the environmental temperature or the like.

Although the embodiment of the present invention has been described with reference to the accompanying drawings, the specific configuration is not limited to that described in the embodiment, and modifications and additions within the scope not departing from the gist of the present invention are included in the present invention.

Although it is determined whether there is a defect in attaching the recording head 22 on the basis of the temperature transition at the time when the recording head 22 is heated in the printing preparation operation in the embodiment, heating of the recording head 22 for determining defective attachment may be performed at another timing. It can be performed at any timing, such as at a time when the power of the apparatus is turned on, at a time when the recording head 22 or the recording head unit 20 is exchanged, and at a time when a user inputs an individual command.

Although defect information (determination history) is recorded in step S107 in FIG. 10, the process may proceed to step S111 at this time point. That is, the process may be terminated at the time when the first defective attachment is detected.

The configuration of the inkjet recording apparatus 10 described in the embodiment is an example, and is not limited thereto. For example, although the inkjet recording apparatus 10 of a type that conveys the recording medium 2 with the conveying belt 12c is exemplified in FIG. 1, the present invention can also be applied to an inkjet recording apparatus of a type that conveys the recording medium 2 by attaching it to a conveying drum.

Furthermore, the heat source for heating the recording head 22 is not limited to the heater 26 and the piezoelectric element 34. For example, in a recording head of a scheme that locally heats ink to a high temperature for a moment with a heating element to generate air bubbles and eject ink, the heating element may be used as a heat source for heating the recording head 22 to determine defective attachment.

Although embodiments of the present invention have been described and illustrated in detail, the disclosed embodiments are made for purposes of illustration and example only and not limitation. The scope of the present invention should be interpreted by terms of the appended claims.

What is claimed is:

1. An inkjet recording apparatus that ejects an ink droplet from a recording head to record an image on a recording medium, the inkjet recording apparatus comprising:
a heat source that heats the recording head;
a temperature sensor that detects a temperature of the recording head;
a carriage to which the recording head is attached; and
a hardware processor that makes determination on whether there is a mechanical defect in attaching the recording head to the carriage on the basis of transition of the temperature detected by the temperature sensor at a time when the heat source heats the recording head.

2. The inkjet recording apparatus according to claim 1, wherein
a plurality of the recording heads is attached to the carriage,
the temperature sensor is provided for each of the recording heads, and
the hardware processor switches a threshold value to be used in the determination according to a position at which a recording head to be determined is attached to the carriage.

3. The inkjet recording apparatus according to claim 1, further comprising:
a second temperature sensor that detects an environmental temperature, wherein
the threshold value to be used in the determination is switched according to the environmental temperature detected by the second temperature sensor.

4. The inkjet recording apparatus according to claim 1, wherein
a plurality of the recording heads is attached to the carriage,
the temperature sensor is provided for each of the recording heads, and
the hardware processor compares transition of the temperature detected by the temperature sensor corresponding to each of the recording heads at a time when each of the recording heads is heated to make the determination.

5. The inkjet recording apparatus according to claim 1, wherein
a driver that generates heat during driving is used as the heat source, the driver being included in the recording head, and
the heating of the recording head for the determination is performed by the driver being driven such that ink is not ejected.

6. The inkjet recording apparatus according to claim 1, wherein
the temperature sensor detects, instead of the temperature of the recording head, a temperature of the carriage in a vicinity of a position at which the recording head is attached.

7. The inkjet recording apparatus according to claim 1, wherein
the hardware processor makes the determination at a time when the recording head is heated in a printing preparation operation.

8. A non-transitory recording medium storing a computer readable program to be executed by a hardware processor of an inkjet recording apparatus including:
a recording head that ejects an ink droplet to record an image on a recording medium;
a heat source that heats the recording head;
a temperature sensor that detects a temperature of the recording head; and
a carriage to which the recording head is attached, the program causing a computer to perform;
heating the recording head with the heat source; and
determining whether there is a mechanical defect in attaching the recording head to the carriage on the basis of transition of the temperature detected by the temperature sensor at a time of the heating.
